(19) United States
(12) Patent Application Publication
(10) Pub. No.: US 2005/0218640 A1
(43) Pub. Date: Oct. 6, 2005

(54) Airbag fabric

(75) Inventor: Akira Kokeguchi, Echi-gun (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/094,256

(22) Filed: Mar. 31, 2005

Related U.S. Application Data
(60) Provisional application No. 60/559,035, filed on Apr. 5, 2004.

(51) Int. Cl. B60R 21/16

(52) U.S. Cl. 280/743.1

(57) ABSTRACT

A fabric for an airbag is provided. The fabric includes a woven fiber web and a coating disposed on the woven fiber web to form a coated surface. The coated surface has a static coefficient of friction of 0.4 or less.

### CROSS REFERENCE TO RELATED APPLICATIONS

This application claims priority to and the benefit of U.S. Provisional Application No. 60/559,035, filed Apr. 5, 2004.

### BACKGROUND

The present invention relates to a fabric for an airbag where the airbag is stored in an airbag module and is inflated to protect a vehicle occupant in the event of a vehicle emergency. More particularly, the present invention relates to a fabric for an airbag having a reduced coefficient of static friction that enables the airbag to deploy more quickly and at a lower inflation pressure.

An airbag device is usually stored within a recess in a vehicle steering wheel or dashboard. The airbag device includes an airbag module, a folded airbag, and an inflator for inflating the airbag. The airbag module has a module cover and a retainer. The folded airbag and inflator are typically mounted to the retainer and are enclosed between the module cover and the retainer. The module cover faces into a vehicle passenger compartment and includes pre-weakened breaking points. In the event of a vehicle emergency, the airbag is inflated by gas produced by the inflator. As the airbag inflates and unfolds, the internal pressure of the airbag module increases until the pre-weakened breaking points fail thereby enabling the airbag to deploy into the passenger compartment. The inflated airbag cushions an impact of the vehicle occupant.

As an airbag unfolds during inflation, surfaces of the airbag move over one another and against interior surfaces of the airbag module. Motion of one surface over another is resisted by friction forces between the surfaces which must be overcome before the surfaces can begin moving relative to each other. Conventional air bag fabrics are woven fabrics having a coating layer disposed on at least one surface of the woven fabric. When the coating layer is applied to the fabric, however, surface irregularities are formed that impede the motion of one surface of the airbag fabric over another surface of the airbag fabric thereby increasing the friction forces between the surfaces. For example, a coating layer applied to a conventional airbag may have surface irregularities, such as bumps. Such coating layers may also include pockets or gaps formed when the coating material sinks into interstices of the woven fabric as the coating layer is applied. As a result, airbag inflation pressure must be increased to compensate for the friction forces so that sufficient energy is available to deploy and fully inflate the airbag.

Additionally, as friction forces increase, the time required for airbag deployment increases because the resistive friction forces slow the motion of one surface over another and because additional time is required to develop the increased internal pressure so that the inflating airbag can burst through the module cover into the passenger compartment. Thus, the ability of the airbag to rapidly inflate to efficiently protect the vehicle occupant is diminished.

### SUMMARY OF THE INVENTION

A fabric for an airbag is provided. The fabric includes a woven fiber web and a coating disposed on the woven fiber web to form a coated surface. The coated surface has a static coefficient of friction of 0.4 or less.

### BRIEF DESCRIPTION OF THE DRAWINGS

The accompanying drawings, which are incorporated in and constitute a part of this specification, illustrate embodiments of the invention, and together with the description serve to explain principles of the invention.

FIG. 1 is a cross sectional side view of an embodiment of an airbag according to the present invention stored in an airbag module.

FIG. 2a is a top plan view of an uncoated woven fiber web of the airbag of FIG. 1.

FIG. 2b is a sectional side view taken along the line A-A of FIG. 2a including a coating layer applied to a top surface of the woven fiber web.

FIG. 3 is a side elevational view of a test apparatus for determining static and kinetic coefficients of friction of a fabric sample.

FIG. 4 is a side elevational view showing a coating apparatus applying a coating to a fabric according to an embodiment of the present invention.

### DETAILED DESCRIPTION

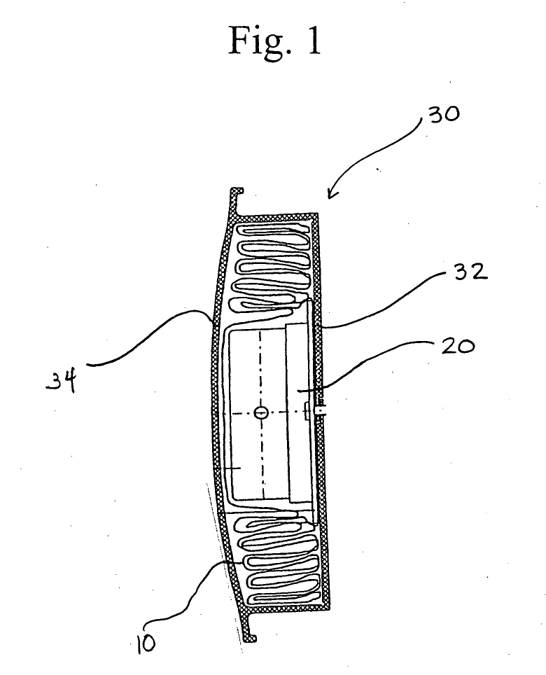

According to an embodiment of the present invention, an airbag device 1 is provided. As shown in FIG. 1, the airbag device 1 includes an airbag 10, an inflator 20, and an airbag module 30.

The airbag 10 and the inflator 20 are disposed within the airbag module 30. The airbag 10 is stored in the airbag module 30 in a folded state, and the inflator 20 is operatively connected to the airbag 10. During a vehicle emergency, the inflator 20 generates inflation gas, which flows into the airbag 10 to inflate the airbag 10.

The airbag module 30 encloses the airbag 10 and the inflator 20. The airbag module 30 includes a retainer 32 and a module cover 34. The retainer 32 supports the airbag 10 and the inflator 20 within the airbag module 30. The cover 34 is connected to the retainer 32. The cover 34 has pre-weakened breaking points (not shown) to enable the inflating airbag 10 to burst through the cover 34 into a vehicle passenger compartment when sufficient pressure develops within the airbag module 30.

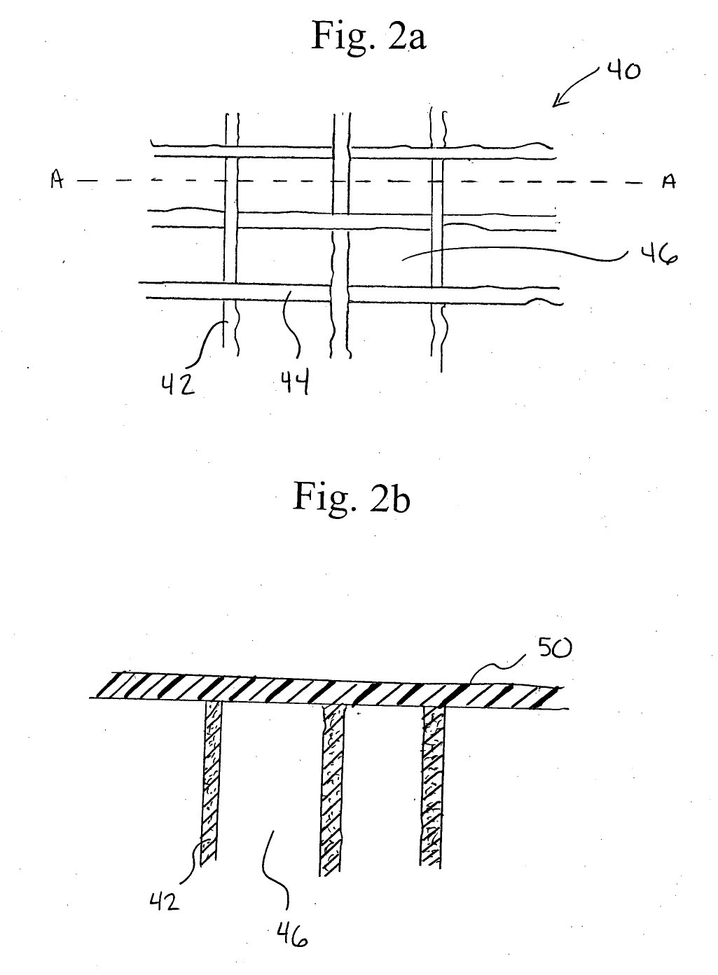

The airbag 10 is formed of a fabric made of a woven fiber web 40, as shown in FIGS. 2a and 2b. FIG. 2a is a top plan view of the uncoated woven fiber web 40. FIG. 2b is a cross sectional side view of the woven fiber web 40 with a coating layer 50 disposed to a top surface of the woven fiber web 40. The woven fiber web 40 includes warp yarns 42, weft yarns 44, and interstices (or spaces) 46 formed between successive yarns. The woven fiber web 40 can be formed of synthetic fibers, such as polyester fibers, polyamide fibers, and the like. More specifically, the woven fiber web 40 may be formed of, for example, fibers of less than 450 denier. Moreover, the woven fiber 40 may have, for example, a woven density of more than 38 fibers per inch in height and/or in width.

The coating layer 50 is disposed on at least one surface of the woven fiber web 40, as shown in FIG. 2b. The coating layer 50 reduces the permeability of the woven fiber web 40 so that high pressure gas generated by the inflator can be contained by the airbag fabric thereby enabling the airbag 10 to inflate.

The coating layer 50 is formed by applying a coating material 52 to the woven fiber web 40 so that a static coefficient of friction μₛ of the coated fabric is 0.4 or less as measured by ASTM D 1894. The coating material 52 is preferably a low coefficient of friction material, such as polytetrafluoroethylene (PTFE), known by the brand name Teflon. For example, the static coefficient of friction μₛ can be 0.3 to 0.4, 0.35 to 0.4, 0.25 to 0.35, 0.2 to 0.3, or 0.1 to 0.2. The static (or starting) coefficient of friction μₛ of a material is related to the force required to begin movement of a first surface of the material over a second surface of the material. In contrast, the kinetic (or sliding) coefficient of friction μₖ is related to the force required to sustain the movement of the first and second surfaces relative to one another. Thus, the static coefficient of friction μₛ provides an indication of the force required to begin movement whereas the kinetic coefficient of friction μₖ provides an indication of the relative difficulty of maintaining the movement.

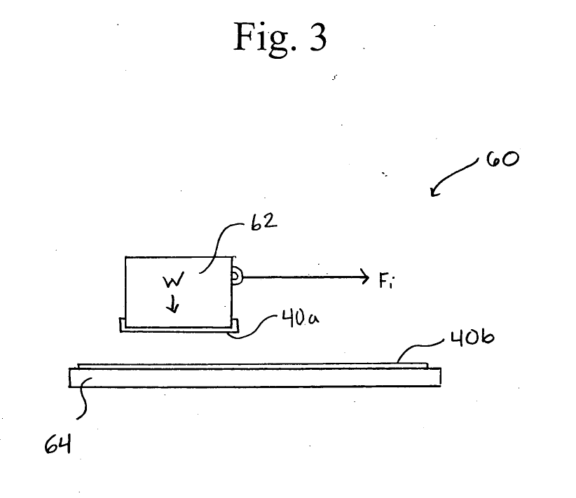

The static coefficient of friction μₛ of a fabric is determined using a test apparatus 60 (shown in FIG. 3), as set forth in ASTM D 1894 and JIS K 7125. A first piece of the fabric 40a is attached (e.g., wrapped) to a sled (or weight) 62, the sled 62 is attached to a drive mechanism (not shown), and the drive mechanism pulls the wrapped sled 62 across a second piece of the fabric 40b that is secured to a horizontal bed (or surface) 64. When the drive mechanism is started, no immediate relative motion takes place because of a static frictional force between the first and second pieces of the fabric 40a, 40b. When the pull on the sled 62 (as measured by a scale or spring gage) is equal to or exceeds the static frictional force between the first and second pieces of the fabric 40a, 40b, the sled 62 begins moving. An initial maximum reading of the scale or spring gage (not shown) attached to the drive mechanism is a force component Fᵢ of the static coefficient of friction μₛ. The static coefficient of friction μₛ of the fabric is determined from the following equation:

$${μ}_{s} = \frac{{F}_{i}}{W}$$

where:
μₛ=static coefficient of friction of the fabric
Fᵢ=initial motion scale reading, and
W=sled weight.

Thus, the static coefficient of friction μₛ is a ratio of the frictional force acting at two contacting surfaces (i.e., the first and second pieces of the fabric 40a, 40b) to a force acting perpendicular to the two surfaces in contact (i.e., the weight of the sled 62). According to ASTM D 1894, the sled weight is 200±5 grams (195 to 205 grams). Therefore, for a sled 62 weighing 200 grams, a static coefficient of friction μₛ of 0.4 or less results in an initial motion scale reading Fᵢ of 80 grams or less. Similarly, for a sled 62 weighing 205 grams, a static coefficient of friction μₛ of 0.4 or less results in an initial motion scale reading Fᵢ of 82 grams or less.

A static coefficient of friction μₛ of 0.4 or less can be achieved, for example, by applying the coating material 52 to the woven fiber web 40 so that surface irregularities of the coating layer 50—such as bumps, protrusions, pockets, and gaps—are reduced and/or substantially eliminated. Bumps and protrusions are due, for example, to uneven application of the coating material 52 on the woven fiber web 40, and pockets and gaps are due to the coating material 52 sinking into the interstices 46 of the woven fiber web 40 during application of the coating material 52. Such irregularities can occur if the woven fiber web 40 is poorly supported (i.e., not stretched tightly or pulled straight) at the point of application of the coating material 52.

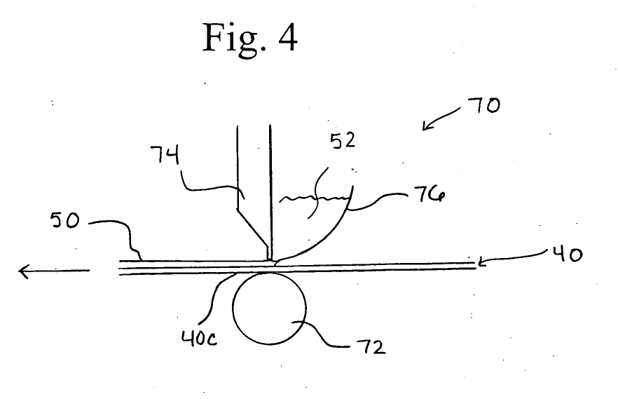

To reduce and/or substantially eliminate surface irregularities, the woven fiber web 40 can be coated in a coating device 70 (shown in FIG. 4) having a support member 72 disposed beneath a coating knife 74 (i.e., beneath the point of application of the coating material 52 to the woven fiber web 40). The support member 72 can be any suitable support structure sufficient to maintain the woven fiber web in a substantially straight and even manner at the point of application of the coating material 52. Preferably, the support member 72 is a roller that extends across a width of the woven fiber web 40.

As the woven fiber web 40 advances through the coating apparatus 70, the support member 72 supports an underside 40c of the woven fiber web 40 at a point beneath the coating knife 74. Thus, as the coating knife 74 applies the coating material 52 (supplied to the coating knife 74 from a coating reservoir 76 as is well known) to the woven fiber web 40 to form the coating layer 50, the woven fiber web 40 is maintained in a substantially even and straight manner by the support member 72.

In this manner, application of the coating material 52 is controlled so that formation of surface irregularities on the resulting coating layer 50 is reduced and/or substantially eliminated so that a static coefficient of friction μₛ of 0.4 or less can be achieved. In other words, the coated surface is substantially even (or planar), and the interstices 46 of the woven fiber web 40 are substantially free of the coating material 52. Reduction of surface irregularities results in a coating layer 50 that is substantially smooth and less resistive to unfolding during inflation. As a result, less inflation pressure is required to inflate the airbag 10, the airbag 10 deploys more quickly, and the occupant receives fewer abrasions caused by impact with the airbag 10. Additionally, because the surfaces of the airbag 10 tend not the get hung up on each other, the deployment shape of the airbag 10 is uniform and controlled.

Thus, according to embodiments of the present invention, a fabric for an airbag is provided having a reduced static coefficient of friction so that an airbag can deploy more quickly and at a lower inflation pressure to rapidly and efficiently protect a vehicle occupant.

Modifications and other embodiments of the invention will be apparent to those skilled in the art from consideration of the specification and practice of the invention disclosed herein. It is intended that the specification and examples be considered as exemplary only, the scope of the invention being limited only by the appended claims.

1. A fabric for an airbag, comprising:
a woven fiber web; and
a coating disposed on the woven fiber web to form a coated surface,
wherein the coated surface has a static coefficient of friction of 0.4 or less.

2. The fabric for an airbag of claim 1, wherein the static coefficient of friction is 0.3 to 0.4.

3. The fabric for an airbag of claim 1, wherein the static coefficient of friction is 0.35 to 0.4.

4. The fabric for an airbag of claim 1, wherein the static coefficient of friction is 0.25 to 0.35.

5. The fabric for an airbag of claim 1, wherein the static coefficient of friction is 0.20 to 0.30.

6. The fabric for an airbag of claim 1, wherein the static coefficient of friction is 0.10 to 0.20.

7. The fabric for an airbag of claim 1, wherein interstices of the woven fiber web are substantially free of the coating.

8. The fabric for an airbag of claim 1, wherein the coated surface is substantially free of irregularities.

9. The fabric for an airbag of claim 1, wherein the coated surface is substantially planar.

10. The fabric for an airbag of claim 1, wherein the fabric comprises a fiber of less than 450 denier.

11. The fabric for an airbag of claim 10, wherein the fabric has a woven density of more than 38 fibers per inch in height.

12. The fabric for an airbag of claim 10, wherein the fabric has a woven density of more than 38 fibers per inch in width.

13. The fabric for an airbag of claim 12, wherein the fabric has a woven density of more than 38 fibers per inch in height.

14. The fabric for an airbag of claim 1, wherein the fabric has a woven density of more than 38 fibers per inch in height.

15. The fabric for an airbag of claim 1, wherein the fabric has a woven density of more than 38 fibers per inch in width.

16. The fabric for an airbag of claim 15, wherein the fabric has a woven density of more than 38 fibers per inch in height.

17. An airbag device for protecting an occupant of a vehicle, comprising:
an airbag module;
an airbag configured to inflate in an event of a vehicle emergency; and
an inflator configured to provide gas for inflating the airbag,
wherein the inflator and the airbag are disposed within the airbag module, and
wherein the airbag is formed of a fabric having a static coefficient of friction of 0.4 or less.

18. A method of coating a fabric for an airbag, comprising the steps of:
providing a woven fiber web;
providing a coating material;
advancing the woven fiber web through a coating apparatus; and
applying the coating material to the woven fiber web in the coating apparatus to form a coating layer on the woven fiber web,
wherein an underside of the woven fiber web is supported at a point of application of the coating material so that the coating layer is substantially free of irregularities, and
wherein the coating layer has a static coefficient of friction of 0.4 or less.
